(19) United States
(12) Patent Application Publication
(10) Pub. No.: US 2017/0225183 A1
(43) Pub. Date: Aug. 10, 2017

(54) REUSABLE SPRAY BOTTLE

(71) Applicant: Albert R. Kelly, Douglaston, NY (US)

(72) Inventor: Albert R. Kelly, Douglaston, NY (US)

(21) Appl. No.: 14/731,708

(22) Filed: Jun. 5, 2015

Related U.S. Application Data
(63) Continuation-in-part of application No. 14/546,985, filed on Nov. 18, 2014.
Application No. 14/546,985 is a continuation-in-part of application No. 14/138,276, filed on Dec. 23, 2013, now abandoned.
Application No. 14/138,276 is a continuation-in-part of application No. 13/342,127, filed on Jan. 2, 2012, now abandoned.
Application No. 13/342,127 is a continuation-in-part of application No. 29/374,376, filed on Aug. 8, 2011, now Pat. No. D671004.

(51) Int. Cl. B05B 11/00; B05B 15/00

(52) U.S. Cl. CPC B05B 11/0097; B05B 11/0008; B05B 11/0037; B05B 15/005; B05B 11/3057

(57) ABSTRACT

Rechargeable containers and dispensers, in particular spray bottle dispensers including structures such as strips, pouches, pills, capsules and the like for providing concentrates of chemical agents for charging or recharging the spray bottle dispenser, preferably, individual chemical refill charges containing chemical concentrate are deployed within the spray bottle dispenser to fully contain any inadvertent spillage of chemicals, and to insure a high degree of safety against accidental spills or ingestion. The device is specifically designed for reuse, having a wider opening which is easier to fill, clean and refill without spills, readily accommodates concentrate inserts in any format, minimizes trigger failure, and has a wide base for stability.

### CROSS-REFERENCE TO RELATED APPLICATIONS

This application is a continuation-in-part of co-pending application Ser. No. 14/546,985, filed Nov. 18, 2014, which in turn is a continuation-in-part of application Ser. No. 14/138,276, filed Dec. 23, 2013, now abandoned, which in turn is a continuation of application Ser. No. 13/342,172, filed Jan. 2, 2012, now abandoned, which in turn was a continuation in part of application Ser. No. 29/374,376, filed on Aug. 8, 2011, now Pat. No. D671,004, the entirety of all of which are incorporated herein by reference thereto.

### FIELD OF THE INVENTION

This invention relates to rechargeable dispensers, in particular, rechargeable spray bottle dispensers, that can be recharged or refilled. Specifically, the present invention is particularly directed to spray bottle dispensers having chemicals associated with them to be dispensed that can be recharged by simply adding water or some other suitable solvent to the spray bottle to form a diluted chemical reagent.

### BACKGROUND OF THE INVENTION

It will be recognized that in today's environment of numerous regulations to control pollution, and consumer and industrial awareness for conserving resources and reducing landfill waste, it is highly desirable to promote the reuse of products that maintain their utility, and dispose of only products that no longer have any utility. Many manufactures are currently selling ready-to-use refills in larger containers to allow consumers to refill spray bottles with their commercial solution. One major brand is doing an on-line market test of a mini-pouch filled with a concentrate that is poured into an empty spray bottle, which is then filled with water. Three refill pouches are offered at the equivalent price of three ready-to-use spray bottles of that same brand.

However, most consumers are reluctant to adopt such methods apparently due to the inconvenience of having to create a use-dilution, in the absence of an attractive cost savings incentive for the added steps involved with the recharging process of the spray bottles. In particular, there is the inconvenience in removing the spray head to open the container, pouring the refill or the chemical concentrate into the empty spray bottle without spilling, refilling the bottle with water, and re-attaching the spray head to the spray bottle. In addition, recharging can be a messy undertaking due to spillage of refills or chemical concentrate while pouring from one container to the other, or accidentally knocking over the bottle being filled due to its instability when empty.

Some spray bottle manufacturers have marketed concentrates in multi-chambered cartridges that fit into standard spray bottle openings, which in turn are punctured by the trigger diptube to release a measured amount of the concentrate into the spray bottle that has been pre-filled with the proper amount of water. These cartridges are costly, and can be broken inadvertently at the risk of spilling or even being swallowed by a small child. Some even supply concentrates in “pods” which are attached to the bottom of a specially designed spray bottle, which when inverted will release a measured amount of concentrate into a chamber, as when turned upright into the body of the spray bottle filled with water.

### SUMMARY OF THE INVENTION

The earlier development by the inventors herein of a unique three piece wide-mouthed spray bottle as is described in application Ser. No. 29/374,376, which issued to Pat. No. D671,004 on Nov. 20, 2012, was key to making the present invention possible. The earlier invention comprises a three-piece unit comprising (1) a bottle with an opening of 1.5 to 3 inches, incorporating screw-threads for attachment of (2) an adaptor-cap which incorporates female screw-threads for attachment to the bottle, and screw-threads for attaching (3) a pump-sprayer device with a trigger handle. Heretofore, all standard spray bottles are configured as two-piece units comprising a bottle containing the liquid formulation to be dispensed, with screw- threads for attaching a pump-spray device/trigger onto an opening of one-inch in diameter. This pump sprayer is the functional component and comprises moving parts which are designed and selected for the intended useful life of the product. The bottles while preferably round in shape may be square, multi-angled, oval or the like.

For consumer products, the pump-spray mechanism is generally limited to its use on a single spray bottle. For institutional products, which are designed for re-use, the pump-spray mechanism is engineered to be more durable and is made suitable for repeated use. For use in the instant invention it is essential that the pump-spray device be engineered for reuse, preferably with plastic components, as metal parts like springs are the items that are prone to fail first.

Pumps that exploit the use of plastic to replace metal springs are supplied by ARMINAK, a fabricator located in Azusa, Calif. What makes the three piece unit of the invention unique is the adaptor-cap, which serves two purposes. The first is to allow for the use of standard pump-spray device or triggers, which are widely manufactured for one-inch diameter openings, and are intended for use with this invention. In this way, if the pump spray device or trigger does fail, the entire wide-mouthed bottle does not need to be replaced. The second important purpose is the ability of the adaptor-cap to accommodate screw-threads for properly attaching and sealing this adaptor-cap to the wide-mouthed opening of between 1.5 and 3 inches in diameter, and preferably at least two inches in diameter. This significantly larger opening makes it much easier to fill the spray bottle with water, and also much easier to clean and to then re-fill with water, than is the case with the standard 1-inch diameter opening. This wide-mouthed bottle is also ideally suited for accepting concentrate-inserts in any format for creating and activating a wide variety of spray bottle solutions, including hard surface cleaners, sanitizers, and disinfectants; plant cleaners and nutrients; pet care products; carpet and fabric care products; odor control products; and virtually any product that can be delivered in a spray bottle format. Significantly, such concentrates can be provided in virtually any form, including liquid concentrates in water-soluble pouches or in measured amounts; as treatments, for example, on fabric composites which can't be broken, swallowed or spilled, or even as powders, capsules or tablets. The re-usability of this wide-mouthed spray bottle is not dependent on the delivery of concentrates in any specific format. Where the re-use of the wide-mouthed spray bottle will be dedicated to the use of a single product formulation, the bottle can be permanently labeled by any method that will survive reuse. If the bottle is to be re-used for different formulations, then its unique conical shape can accommodate use of hood-shaped plastic labels that would be held in place by the closure of the pump-spray device, and not interfere with the application or removal of the applicator-cap.

Possible manufacturing materials for the wide-mouth spray bottle include polycarbonate, the same material as some soda and water bottles are made from, as these materials are extremely durable and water clear. There has been some concern about using this material to package consumable food products, as it contains bisphenol-A (BPA), a substance suspected of impacting hormonal chemistry in the body. However, it is not a significant concern in applications involving cleaning materials. There is a substitute material being used, TRITAN™ resin which has the same properties as polycarbonate but without the BPA. It is more costly than polycarbonate but is advantageous in applications where BPA must be avoided or minimized. The cap can also be injection molded in either polycarbonate or TRITAN™ if clarity is needed. If not, polypropylene could be used either in a natural or semi-transparent effect, or in bright colors. This is a reasonably inexpensive material that is strong and break resistant. Various styrenes can also be considered but these are not necessarily as impervious to breakage.

Among the key benefits of the spray bottle of the invention, the following may be noted: (1) designed for reuse—wider opening (wide mouth or “Smart Mouth™”) is easier to fill with water without spilling, easier to clean, and easier to refill; (2) readily accommodates concentrate inserts in any format—liquid solutions in measured amounts, water-less liquids or powders in water-soluble pouches, liquids or powders embedded in nonwoven fabric sleeves, or soluble tablets or capsules; (3) trigger failure will be minimized by use of all plastic components, as opposed to metallic springs, and will not require total spray bottle replacement, as was the case with other known wide mouthed bottles. Structural benefits include: (1) plastic spray bottle can be clear, translucent, or opaque; (2) shape is conducive to maintaining uniform wall thickness in blow molding; (3) shape is not critical, can be square, rectangular, multi-angled or the like; (4) wider base makes it more stable; and (5) easy-on, easy-off screw top is more convenient to use.

The subject improved system may be made and used in accordance with the apparatus and methods described in detail below. The invention also lends itself for use with particulate products not readily soluble in water or other diluents. In this case, the particulate products may have particles reduced in size to nanoparticle sizes and in this form incorporated into the delivery mechanism as, for example, a non-woven strip, plastic pouch or the like. Clogging of the trigger mechanism by non-soluble particles is thereby avoided. Other additives and agents to be supplied for recharging of the bottle will not settle out or interfere with delivery of the product through the spray nozzle.

In the embodiment of the composite disc-shaped insert, the elongated recharge insert is preferably provided with, at its outer circumference, angular cuts so as to provide a disc approximately the shape of a polygon, i.e., hexagon, octagon, nonagon and the like, for and in its insertion and providing the insert protection and ease of insertion and also spray charge active agents before use and exposing the active agents when the insert is deployed. It should be appropriate that the insert need not be restricted to a certain shape. In the case of the invention, the general elongated shape is preferable.

Preferably, the absorbent composite material is a synthetic or , nonwoven substrate. The composite substrate should preferably be comprised of natural or synthetic fibers such as PLA, rayon, Tencel, and/or other substrates that can be needle punched and bonded without the use of chemical binders. The cleaning sanitizing or disinfectant chemical composition is impregnated into the nonwoven material by coating a precise amount of chemical concentrate. The composite material has a desired porosity to allow fluid to penetrate through the material and dissolve the chemical composition impregnated therein. The concentrate is delivered, i.e., impregnated, into the precut nonwoven material preferably by introducing the precut material into a pouch containing or filled with concentrate in a precise amount, and the pouch sealed. The concentrate in the pouch will penetrate the composite of the nonwoven substrate and chemical concentrate and when the water is added to the contents of the pouch will form a ready to use treatment.

When the spray bottle containing the insert is filled with water, sealed, and shaken, the chemical composition becomes dissolved in solution, thereby creating a ready-to-use cleaning, sanitizing or disinfectant solution that will remain stable and fully active.

In a preferred embodiment of the recharge insert or the sleeve composite, the cleaning, sanitizing or disinfectant chemical composition is impregnated into the adsorptive material by injection or slot-coating a precise amount of concentrate.

The application/mounting of the sleeve can be achieved without the user touching the sleeve. When the spray bottle is filled with water, sealed with the sealing cap, and shaken, the chemical composition impregnated in the absorptive material of the sleeve becomes dissolved by the fluid to form a cleaning, sanitizing or disinfectant solution.

Obviously, alternative sequences of steps for recharging can be followed. For example, the sleeve can be mounted to the diptube before the retainer is attached at the lower end of the diptube.

The insert can be easily inserted into the container without requiring the user to touch the insert's treated core by hand, thereby eliminating any possibility of direct contact between the user's skin and the treated core containing highly concentrated and potentially skin sensitizing or irritating treatment compositions. When the spray bottle, with insert contained therein, is filled with water, sealed, and shaken, the chemical composition becomes dissolved, thereby creating a ready-to-use cleaning, sanitizing or disinfectant solution that will remain stable and fully active compared to the use of raw liquid concentrates in preparing ready-to-use solutions, these inserts are portion controlled and far safer to handle and use because the matrix is designed to prevent direct skin contact with the chemical composition and is not subject to being spilled, broken or swallowed.

The objects, features, and advantages of the present invention will be explained in the following detailed description of the invention having reference to the appended drawings.

Other objects, features and advantages of the present invention will be apparent when the detailed descriptions of the preferred embodiments of the invention are considered with reference to the accompanying drawings, which should be construed in an illustrative and not limiting sense as follows.

### BRIEF DESCRIPTION OF THE DRAWINGS

For the purposes of illustrating the various aspects of the invention, wherein like numerals indicate like elements, there are shown in the drawings simplified forms of the device of the invention that may be employed, it being understood, however, that the invention is not limited by or to the precise arrangements shown. The drawings may not be to scale, and the aspects of the drawings may not be to scale relative to each other. To assist those of ordinary skill in the relevant art in making and using the subject matter hereof, reference is made to the appended drawings and figures, wherein:

FIG. 1 is a cross-sectional view of a spray bottle apparatus;

FIG. 2A is a front elevation view of an opened recharge insert assembly;

FIG. 2B is a rear elevation view of an opened recharge insert assembly;

FIG. 2C is a side elevation view of an opened recharge insert assembly;

FIG. 3 is a cross-section of a further embodiment of a multi-ply recharge insert assembly;

FIG. 4A is a perspective view of an embodiment of a recharge insert assembly having a two-ply structure;

FIG. 4B is an end view of a two-ply structure of a recharge insert assembly having a two-ply structure;

FIG. 5 is an end view of an embodiment of a recharge insert assembly having a four-ply structure;

FIG. 6 is an exploded view of an embodiment of the subject recharge insert adaptor assembly showing the recharge insert held firmly in an upright position with the labeling facing outwardly;

FIG. 7 is a partial cross-section of the spray recharge system insert shown in FIG. 6 with the bottle in the upright position;

FIG. 8A is a showing of step 1 of the system wherein a spray bottle is opened by removing the lid;

FIG. 8B is a showing of step 2 of an embodiment of the system wherein a packet containing an impregnated disc is opened to expose the disc;

FIG. 8C is a showing of step 3 of an embodiment of step 2 wherein the disc is removed from the packet and dropped into the bottle;

FIG. 8D shows the spray bottle containing the disc at the bottom thereof being filled with water;

FIG. 8E shows the lid of the spray bottle being resealed onto the spray bottle;

FIG. 8F shows the resealed bottle of FIG. 8E being agitated to form the use dilution;

FIG. 9A is a showing of step 1 of an embodiment of the system of a used spray bottle being opened;

FIG. 9B is a showing of step 2 of the invention wherein the used disc is removed from the spray bottle;

FIG. 9C is a showing of step 3 of the invention wherein a refill disc is dropped into the spray bottle;

FIG. 9D shows the spray bottle containing the disc at the bottom thereof, being filled with water;

FIG. 9E shows the lid for the spray bottle being resealed thereon;

FIG. 9F shows the resealed bottle of FIG. 9E being agitated to form the use dilution;

FIG. 10 is a front, side, and rear elevation view of a spray container;

FIG. 11 is a top perspective view of the spray container of FIG. 10;

FIG. 12 is a bottom perspective view of the spray container of FIG. 10;

FIG. 13 is a top view of the spray container of FIG. 10;

FIG. 14 is a bottom view of the spray container of FIG. 10; and

FIG. 15 is a top perspective view of the spray container of FIG. 10.

### DETAILED DESCRIPTION OF THE PREFERRED EMBODIMENTS

The subject rechargeable liquid spray system is comprised of: (a) a container for holding a liquid for spraying applications and having a neck opening sufficiently wide to receive or remove a replaceable spray charge insert; and (b) a spray head engaged above the upper neck opening of the liquid container for reaching liquid from the bottom of the container, the spray head also having a trigger for drawing the liquid and a nozzle for spraying the activated liquid on a surface.

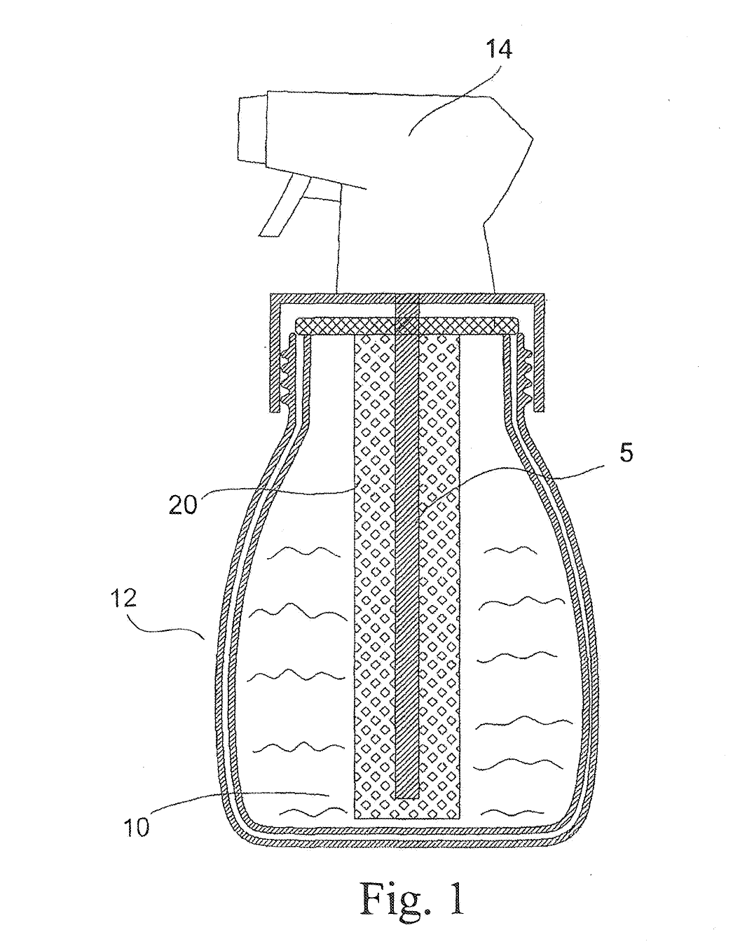

FIG. 1 is a cross-sectional view of a spray bottle apparatus 12 for use in an embodiment of the subject system. Spray system apparatus 12 has a standard trigger spray head 14 configured to engage and fit on a wide-mouth style container 12. In accordance with the invention, spray head 14 also has a diptube 5 for drawing the liquid contents of the container. In FIG. 1, recharge insert 10 is shown in relation to container 12, spray head 14 and diptube 5. Recharge insert 10 is described in further detail below.

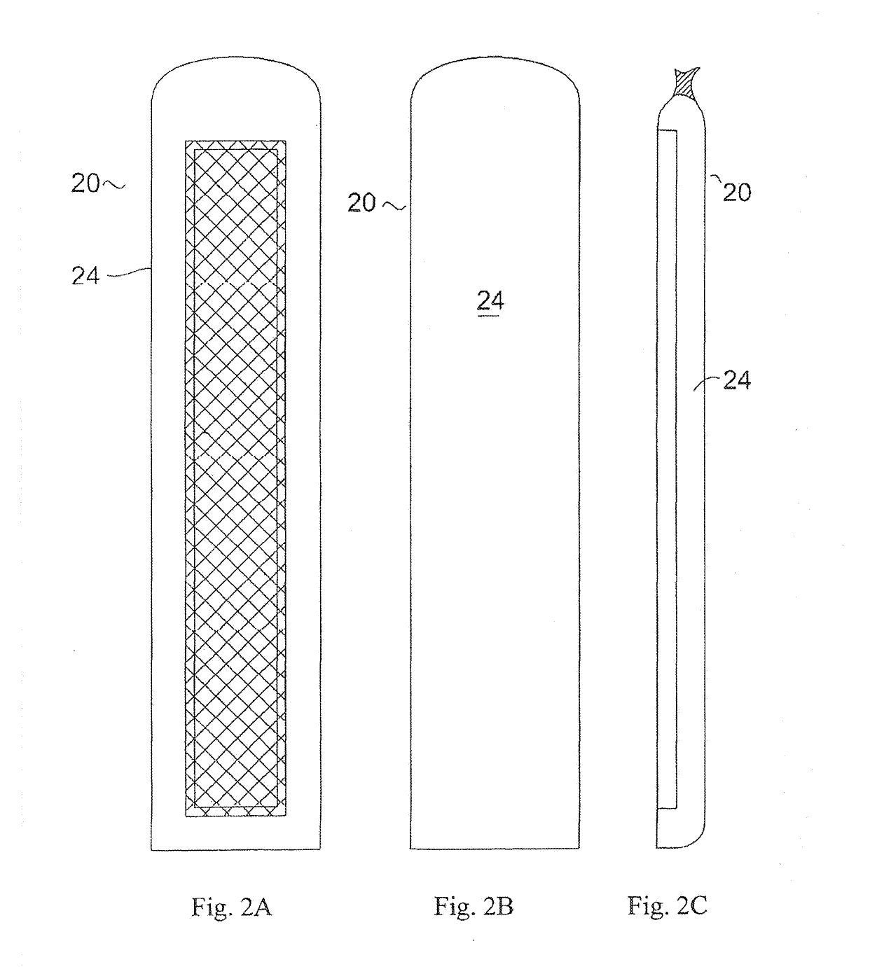

FIG. 2A is a front elevation view of an opened recharge insert assembly. FIG. 2B is a rear elevation view of the opened recharge insert assembly 20 shown in FIG. 2A showing backing 24 which is suitable for printed advertising, directions or the like. FIG. 2C is a side elevation view of the opened recharge insert assembly 20.

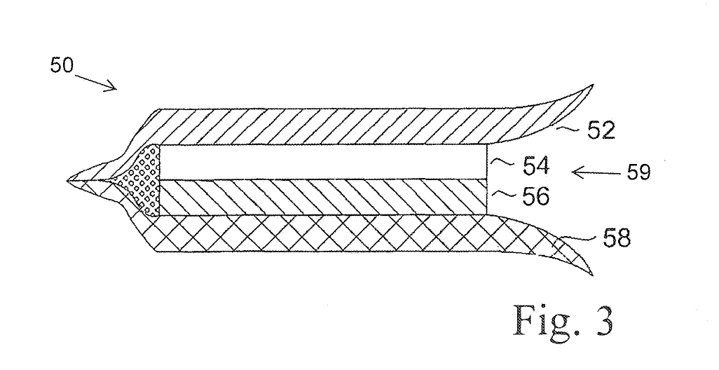

FIG. 3 is a cross-section of a further embodiment of a multi-ply recharge insert assembly 50 wherein outer packaging layers 52 and 58 have been partially peeled away to expose functional insert layers 54 and 56. Void 59 is depicted in this figure between sealed layers 52 and 58.

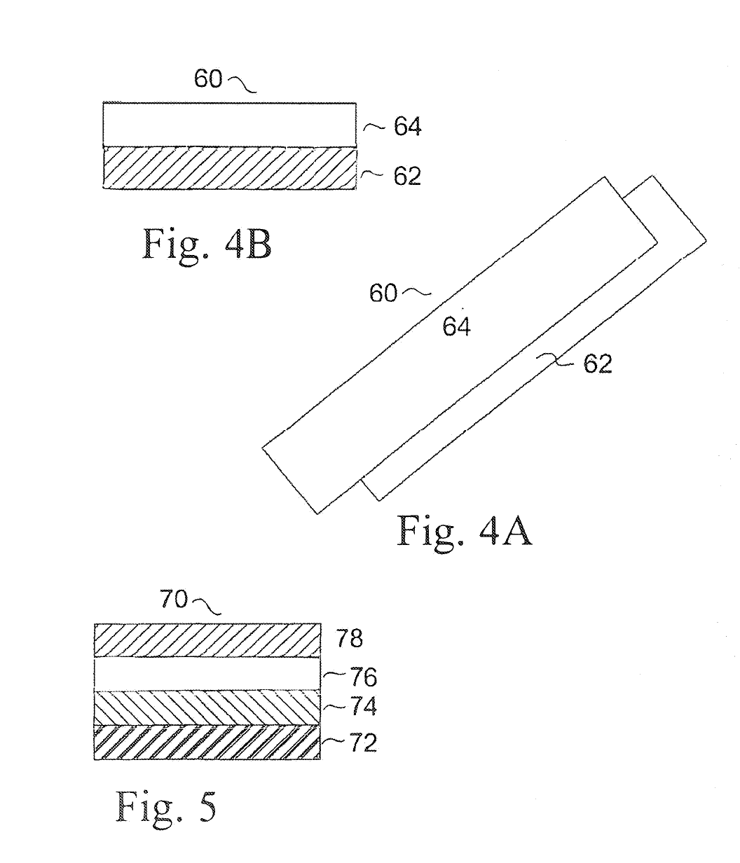

FIG. 4A is a perspective view of an embodiment of recharge insert assembly 60 having a two-ply structure, wherein backing 62 is shown in relationship to functional insert layer 64. FIG. 4B is an end view of the two-ply structure of the recharge insert assembly 60 shown in FIG. 4A.

FIG. 5 is an end view of an embodiment of recharge insert assembly 70 having a four-ply structure having lower barrier layer 72, functional insert layer 74, porous mesh layer 76, and upper or outer barrier layer 78.

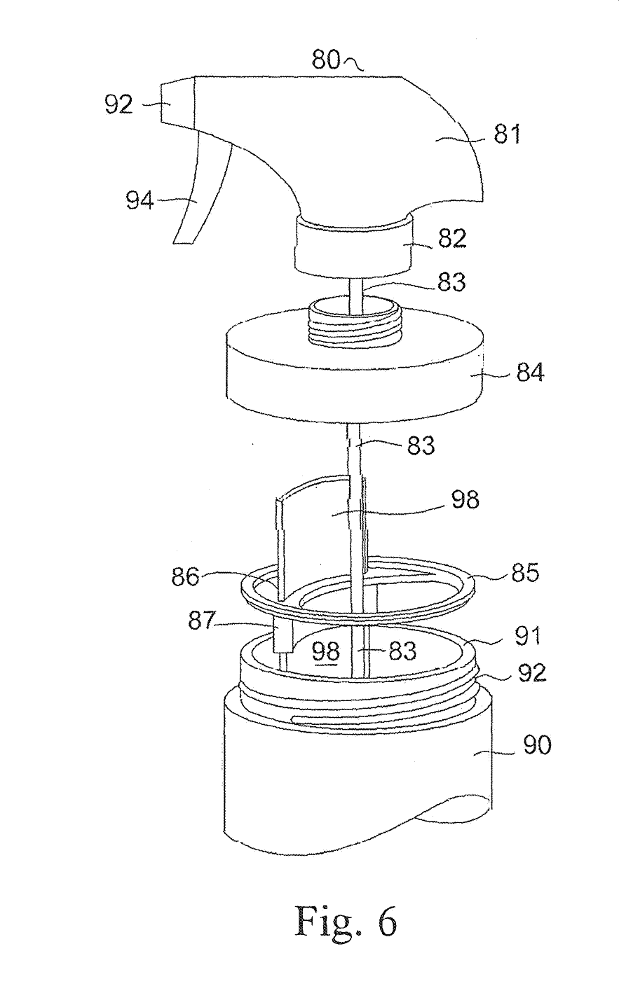

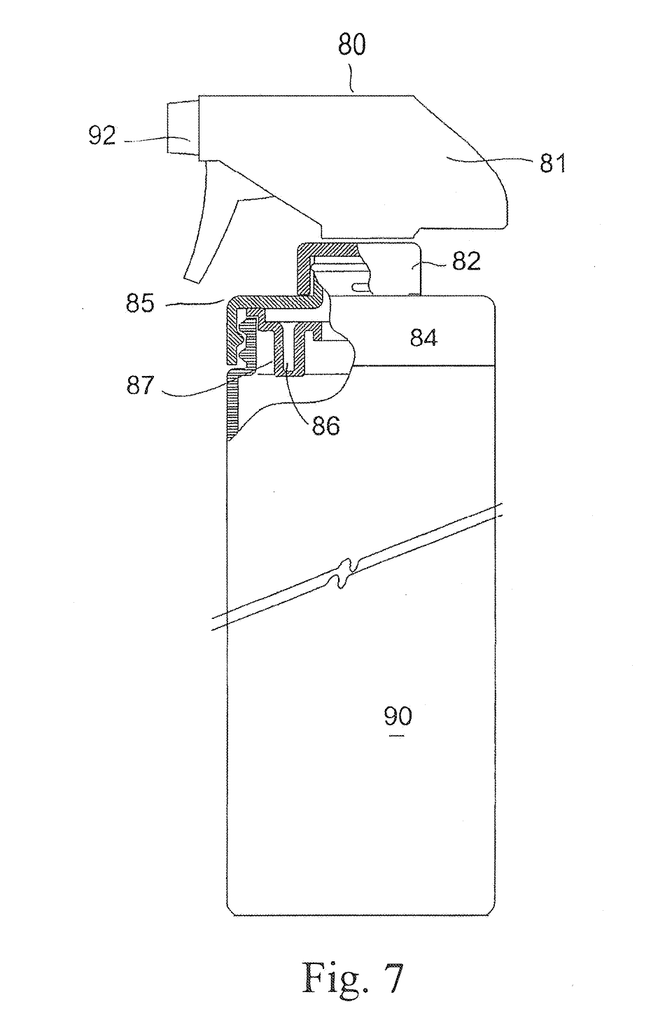

FIG. 6 is an exploded view of an embodiment of the subject recharge insert assembly 80 having spray head 81, nozzle 92, trigger 94, diptube 83 and screw cap 82 for engaging screw threads on collar 84. Collar 84 is configured to be placed in the top part of container 90 and is adapted to hold a recharge insert in opening 86, which is reinforced in this embodiment by descending portion 87. In this manner, a recharge insert will be held upright near the side wall of the bottle for easy viewing of the labeling. Collar 84 may be screwed onto container 90 with threads 92 at container opening 91 which engage insert adaptor 85 provided with an opening 86 and reinforced by a descending portion 87. In FIG. 6, spray recharge insert 98 has been placed partially in insert adaptor 85 and a portion of insert 98 can also be seen within container 90.

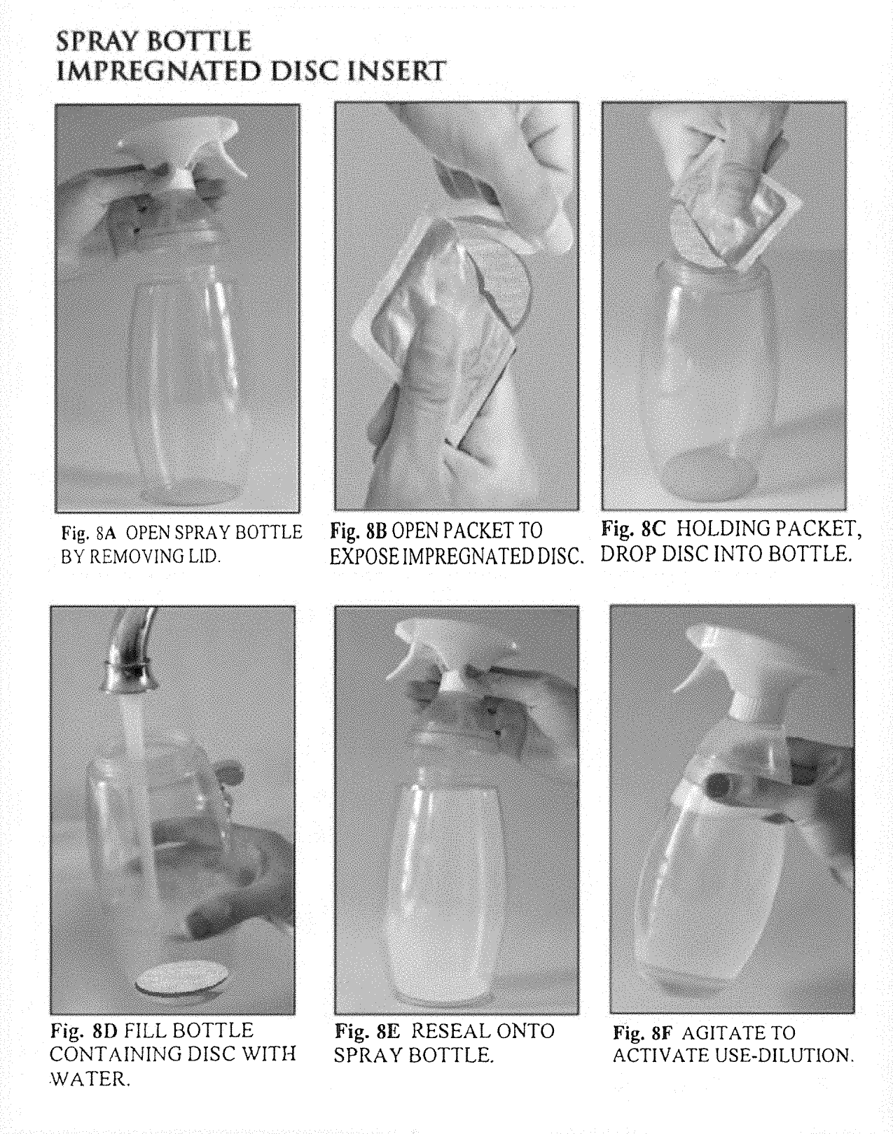

FIGS. 8A-8F show a disc-shaped recharge insert in position within the liquid container for holding the liquid for spraying applications, a spray head of a conventional construction engaged above the upper neck opening, the sprayhead having a trigger for withdrawing the liquid contents of the container, with a nozzle for spraying the liquid on a surface, wherein a recharge insert is shown in relation to the container sprayhead before and after insertion of the recharge insert into the wide mouthed container. FIGS. 8A-8F show photographic views of the recharge insert assembly and the following: introducing the insert; filling the container with water to form the application fluid from the concentrate in the insert.

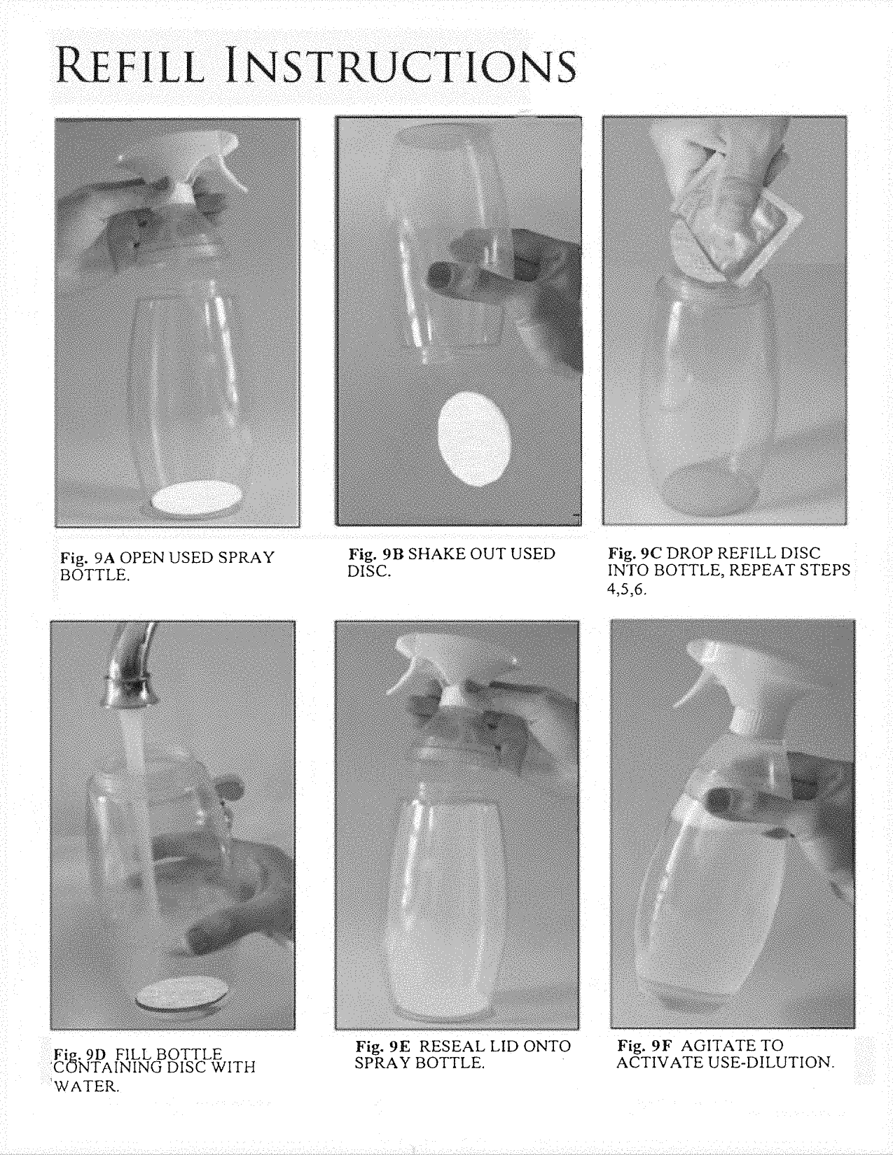

FIGS. 9A-9F show photographic views of the spray bottle apparatus being opened and refilled for recharging the spray bottle apparatus. FIGS. 9A-9F show an embodiment of the rechargeable liquid spray system of the invention and illustrate refill instructions.

This invention provides an easy-to-use and safe-to-handle device for creating ready to use cleaning, sanitizing, degreasing, and/or disinfecting spray bottle solutions. The recharge insert is an entirely self-contained device which is designed exclusively for use with the wide-mouth spray bottles and spray heads in accordance with the invention. The compact, stand-alone insert makes it incredibly simple to recharge spray bottle solutions, and to thereby substantially reduce solid waste landfill contamination. They will also reduce the enormous shipping, handling, and storage costs associated with their prolific use commercially and at home of the spray bottle solutions.

Suitable translucent bottles having a satisfactorily wide container opening are commercially available in 16, 24 and 32 ounce sizes from Tablecraft, located in Gumee, Ill.

In addition to being easier to use, this new insert device is designed to accommodate use of larger dimensions of nonwoven materials without regard for the fiber blends involved that can effectively deliver significantly larger amounts of the concentrates. Whereas that option can significantly expand loading capacity, it also mandates that the carrier device facilitate easy insertion and extraction of the impregnated nonwoven material into and from the dilute solution, and that it provide structural support for the nonwoven material when in the solution.

The unique insert is structurally designed to provide a mechanism that simplifies the procedure for creating a use-dilution while eliminating the need to handle or touch the cleaning, sanitizing or disinfecting agents impregnated into the nonwoven core in the process of doing so.

With this new insert device, the opportunities for creating cleaning, sanitizing, degreasing or disinfectant use-dilutions are expanded considerably, due in part because the activation process itself is far more simplified. An end-user simply removes the two-piece top from the wide-mouth bottle, empties and refills the bottle with fresh water, and then places the insert into the filled bottle thereby allowing the concentrate to be diluted and create a ready-to-use solution. The spray bottle as rendered in one of the drawings illustrates how this system can be assembled without having to build a whole new set of expensive spray bottle tooling and molds. A spray bottle system of this type is needed to accommodate the 2-inch wide insert of the invention which is a key element of the new concept, and which will be described in greater detail by the following.

The preference for use of the recharge system of the invention was driven by its demonstrated ability to reduce solid waste and both shipping and inventory costs by up to 90%.

The subject recharge insert may be seen to facilitate simplification of several essential aspects of the spray system technologies, including reduced dependence on super concentrated formulations, less complicated fiber specifications and blends for the nonwoven cores, and easier to use inserts that include labels for creating specific ready-to-use cleaning solutions for use in wide-mouthed, unlabeled spray bottles, thereby reducing the necessity for using dedicated, pre-labeled spray bottles.

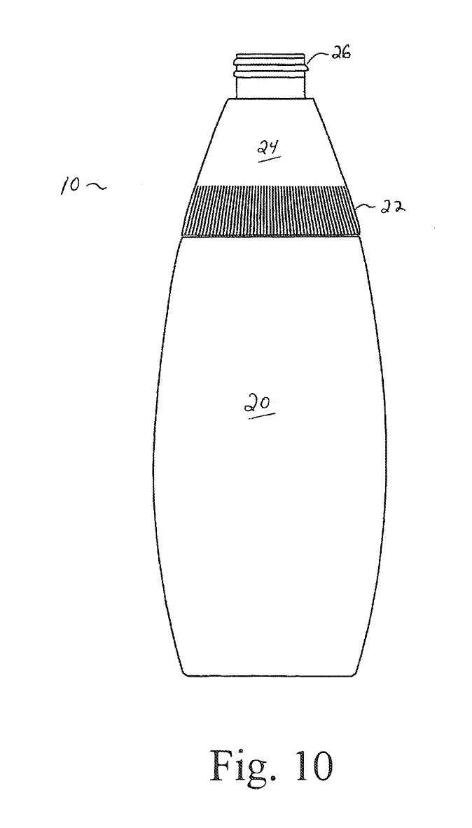

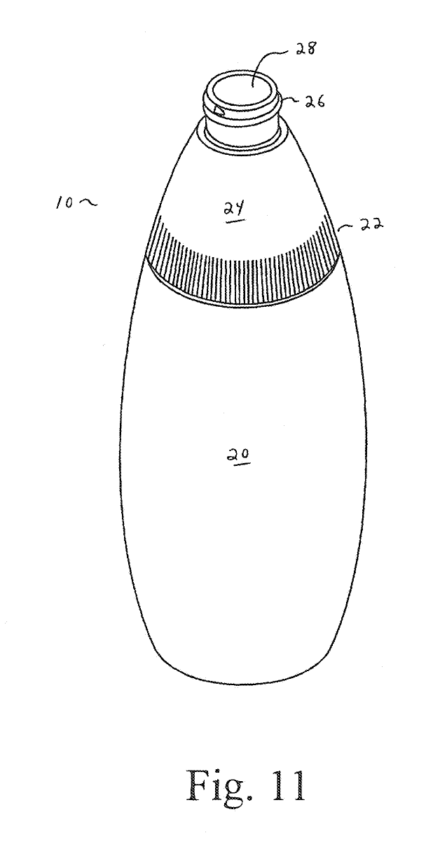

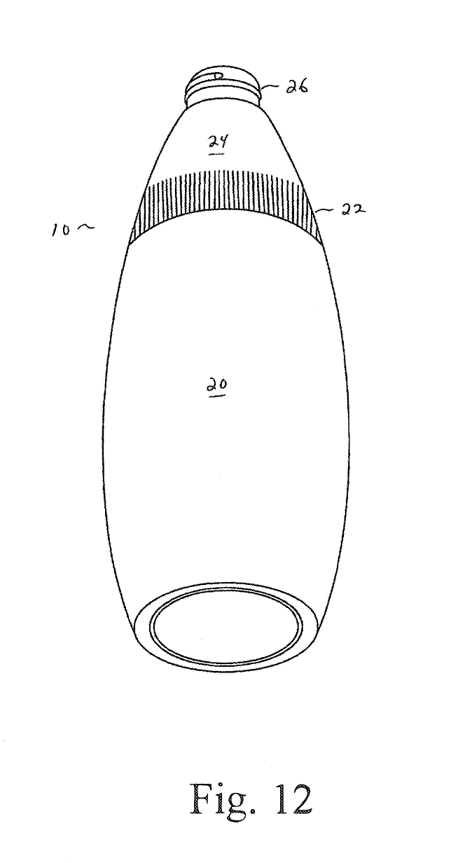

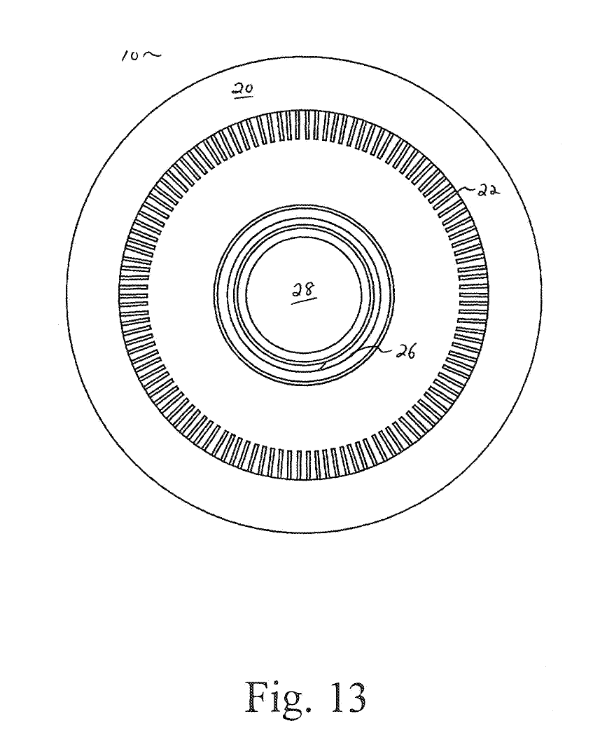

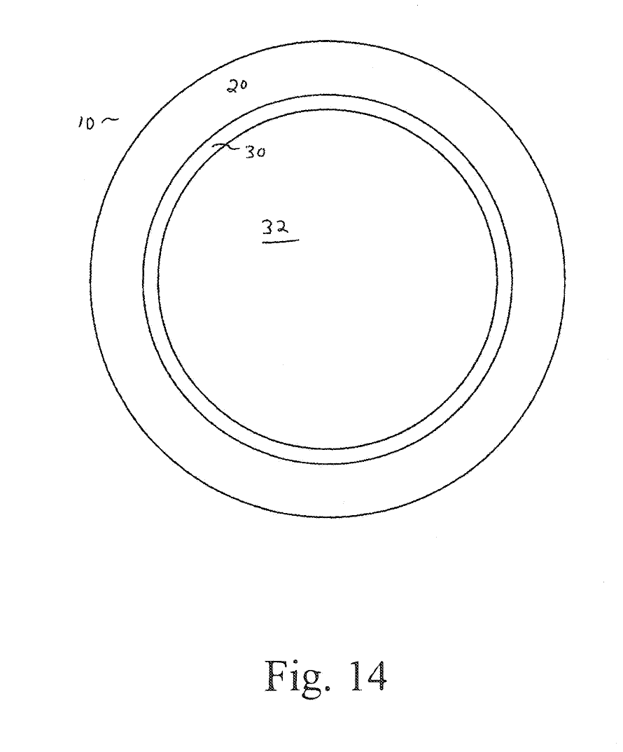

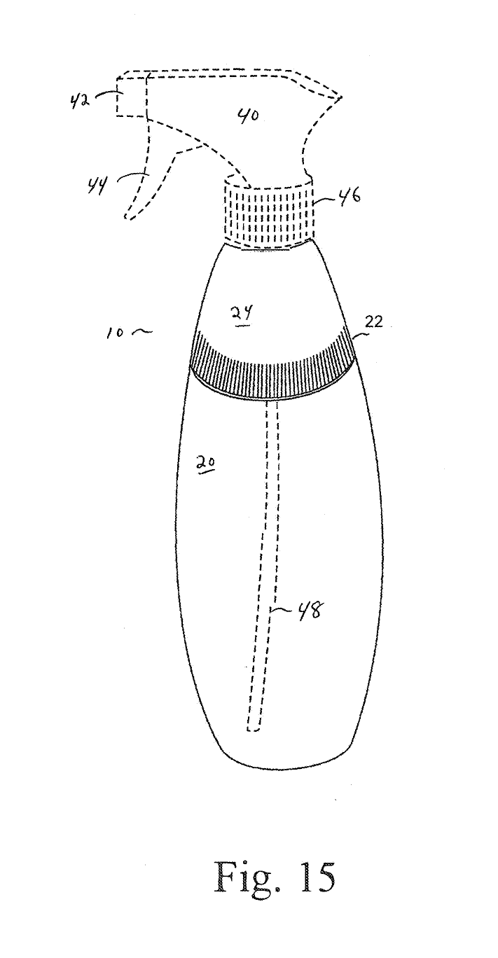

Referring now to FIGS. 10-15, the rechargeable spray dispenser bottle 10 comprises a bottle 20 having an opening of 1.5 to 3 inches provided with screw threads (not visible but the location of which is indicated by reference label 22 in FIGS. 10, 11, 12, 13, and 15) for attachment of an adaptor cap 24 which incorporates female screw threads (not visible but the location of which is also indicated by reference label 22 in FIGS. 10, 11, 12, 13, and 15) for attachment to the bottle 20 and screw threads 26 for attaching a pump sprayer device 40 having a trigger handle 44 and a spray opening 42 (as shown in FIG. 15). FIGS. 11 and 13 show an opening 28 in adaptor cap 24. Referring to FIG. 15, the pump sprayer device 40 is connected to a diptube 48 which on activating the handle 44 causes spray solution to be delivered from the bottle 20 up through the diptube 48, out through the opening 28, and out through the spray opening 42. The bottle's bottommost part as shown in FIG. 14 is provided with a concave edge 30 and a dome shaped bottom 32.

The subject improved spray bottle system may be made and used in accordance with the apparatus and methods described in detail below.

Those skilled in the art will recognize that any type of clear, translucent, transparent, semi-transparent, or opaque material may be used to make the bottle container, thermoplastic resins being preferred.

Preferably, the container is made of thermoplastic polymer, for example, polycarbonate, polyethylene terephthalate, polybutylene terephthalate, polyurethane and similar moldable plastics. The containers may be blow molded to suitable size and shape.

In other embodiments, the spray bottle may comprise other materials to offer more variety and decorative options while maintaining the same function as with clear thermoplastic polymer material. In accordance with at least one embodiment, the spray containers may be made in different sizes.

An example of a rechargeable cleaning or sanitizing system which is particularly useful with the present spray bottle device is disclosed in Pat. No. D671,004 which is incorporated herein by reference.

### EXAMPLE 1

The formulation for EPA Registration No. 62401-7, an approved food contact cleanser and sanitizer, was impregnated into a 22 lb. needlepunch composite 50/50 blend of polypropylene and polyethylene fibers with a thickness of about ⅜ inches. In accordance with the approved EPA registration, a 220% add-on of this formulation was uniformly injected or impregnated into this matrix, which was then cut into rectangular pad-inserts, measuring 1.5 inches in width by 2.5 inches in length. The resulting pad had a treated weight of 4.79 grams, of which 2.98 grams was the approved formulation. The formulation was introduced into the composite in a precise amount and namely an amount to produce the required concentration for application of the treatment solution.

The pad/insert was then dropped into the wide-mouthed spray bottle, where it settled neatly on the bottom surface, leaving space for the bottom of the diptube to access the entire outer circumference of the bottle's bottom surface to facilitate complete withdrawal of the activated use-dilution from the spray bottle. Twenty-four ounces of clean water were then added to fill the spray bottle, which was then sealed and shaken until all of the treatment formulation was dissolved, as evidenced by the colorless pad/insert.

The trigger was then activated and yielded a 200 PPM quaternary solution, as specified by the approved food contact surface cleaning and sanitizing EPA Registration No. 62401-7.

### EXAMPLE 2

A proprietary glass and window cleaning formulation, containing a volatile component requiring a barrier packaging film to maintain stability, was used to prepare this sample. This concentrate included dipropylene glycol n-butyl ether as the solvent, and potassium hydroxide for adjusting the pH. For this product, an effective 24-ounce use dilution requires that the concentrate comprise an add-on of at least 325% of the basis weight of the same 22 lb. composite and 50/50 blend of fibers as employed in Example 1, supra. After this composite was slot-coated with the required add-on, and was cut into rectangular pad-inserts measuring 1.5 inches in width by 2.5 inches in length, the treated pad inserts weighed 7.66 grams, of which the added concentrate comprised 5.86 grams.

Typically, nonwoven composites will readily absorb and hold up to four times their basis weight without releasing the add-on prematurely. The 325% add-on was well within that range, and did not leak from the barrier film pouch in which it was subsequently wrapped.

The treated pad-insert was then dropped into the wide-mouthed spray bottle, and settled neatly on the bottom surface, leaving space for the end of the diptube to access the entire circumference of the bottle's bottom surface to facilitate withdrawal of the activated use-dilution. Twenty-four ounces of clean water was then added to fill the spray bottle, which was then sealed and shaken until the entire treatment formulation was dissolved, as evidenced by the colorless pad-insert.

The trigger was then activated and used to spray the glass cleaning formulation onto a variety of glass and other polished surfaces, all of which were free of any dust, dirt, or greasy residue as a result of the use of the formulation.

The invention herein contemplates the use of a three-piece, wide-mouthed spray bottle which comprises a three-piece unit comprising (1) a bottle with an opening of 1.5 to 3 inches, incorporating screw-threads for attachment of (2) an adaptor-cap which incorporates female screw-threads for attachment to the bottle, and screw-threads for attaching (3) a pump-sprayer device with a trigger handle via a second opening of about 1 inch in diameter. What makes the three-piece unit of the invention unique is the two different size openings of the adaptor-cap, which serves two purposes. The first is to allow for the use of standard pump-spray device or triggers, which are widely manufactured for one-inch diameter openings, and are intended for use with this invention. In this way, if the pump spray device or trigger does fail, the entire wide- mouthed bottle does not need to be replaced. The second important purpose is the ability of the adaptor-cap to accommodate screw-threads for properly attaching and sealing this adaptor-cap to the wide-mouthed opening of between 1.5 and 3 inches in diameter, and preferably at least two inches in diameter. This significantly larger opening makes it much easier to fill the spray bottle with water, and also much easier to clean and to then re-fill with water, than is the case with the standard 1-inch diameter opening. This wide-mouthed bottle is also ideally suited for accepting concentrate-inserts in any format for creating and activating a wide variety of spray bottle solutions, including hard surface cleaners, sanitizers, and disinfectants; plant cleaners and nutrients; pet care products; carpet and fabric care products; odor control products; and virtually any product that can be delivered in a spray bottle format. Significantly, such concentrates can be provided in virtually any form, including liquid concentrates in water-soluble pouches or in measured amounts; as treatments, for example, on fabric composites which can't be broken, swallowed or spilled, or even as powders, capsules or tablets. In the world of spray bottles, there has heretofore been no bottle construction as described by the applicant. The applicant, in fact, has obtained a design Pat. No. D671,004 S, supporting its uniqueness.

It will be recognized by those skilled in the art that many variations of the above descriptions may be employed in other embodiments of the subject invention.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be utilized without departing from the spirit and scope of the present invention as defined by the appended claims.

The invention now being fully described, it will be apparent to one of ordinary skill in the art that many changes and modifications can be made thereto without departing from the spirit or scope of the invention set forth herein.

1. A rechargeable dispenser, comprising: a bottle portion; a resealable closure connected to said bottle portion, said resealable closure configured to be opened to allow liquid contents to flow there through and closed to seal said bottle portion, said resealable closure being a screw type spray head; and a chemical refill insert configured to be disposed within said dispenser, said insert including being adapted for containing and storing a measured amount of concentrate agent, said insert being disposed within said dispenser and within said bottle portion of said dispenser.

2. A rechargeable dispenser according to claim 1 wherein said pump sprayer device is suitable for repeated use.

3. A rechargeable dispenser according to claim 1 wherein said pump sprayer device is constructed of plastic.

4. A rechargeable dispenser according to claim 1 wherein said bottle has an opening of at least 2 inches in diameter.

5. A rechargeable dispenser according to claim 1 wherein said bottle is suited for accepting concentrate inserts for activating a wide variety of spray bottle solutions.

6. A rechargeable dispenser according to claim 5 wherein said concentrate insert includes a hard surface cleaner, sanitizer, disinfectant, plant cleaner, plant nutrient, pet care product, carpet cleaner, fabric fresheners or odor control product.

7. A rechargeable dispenser according to claim 6 wherein said concentrate is a liquid concentrate.

8. A rechargeable dispenser according to claim 1 wherein said bottle is made of polycarbonate.

9. A rechargeable dispenser according to claim 1 wherein said bottle is made of Tritan™.

10. A rechargeable dispenser according to claim 1 wherein said concentrate is a particulate product, the particles being of nanoparticle size.

11. A rechargeable dispenser according to claim 10 wherein said particles are incorporated into a woven strip.

12. A rechargeable dispenser according to claim 3 wherein said pump sprayer device is constructed of a thermoplastic polymer selected from the group consisting of polycarbonate, polyethylene terephthalate, polybutylene terephthalate and polyurethane.

13. A rechargeable dispenser according to claim 7 wherein said concentrate is a liquid concentrate incorporated into a disc shaped woven strip having a generally elongated shape.

14. A method of recharging a spray bottle dispenser according to claim 1 which comprises removing the spray head to open the spray bottle dispenser, introducing a measured amount of concentrate or refill into the empty bottle, refilling the bottle with water and reattaching the spray head to the bottle.

15. A method according to claim 14 wherein said concentrate is a liquid, pill, capsule or impregnated nonwoven fabric strip.

16. A rechargeable dispenser according to claim 5 wherein said bottle is round in shape.

17. A rechargeable dispenser according to claim 5 but wherein the bottle is oval in shape.

18. A rechargeable dispenser according to claim 5 but wherein the bottle is square in shape.

19. A rechargeable dispenser comprising a three piece unit comprising (1) a bottle having a first opening of 1.5 to 3 inches, incorporating screw threads for attachment of (2) an adaptor cap having two different size openings which incorporates female screw threads for attachment to the bottle's first opening and screw threads for attaching (3) a pump sprayer device having a trigger handle and pump sprayer device being attached to the second opening of about 1 inch in diameter of the adaptor cap.

20. A rechargeable dispenser according to claim 19 wherein said bottle is suited for accepting a concentrate insert comprising a disc shaped woven strip having a generally elongated shape and formed from synthetic or natural binder free fibers which have been bonded without the use of chemical binders and impregnated with a concentrate in a precise amount selected from the group of hard surface cleaners, sanitizers, disinfectants, plant cleaners, plant nutrients, pet care products, carpet cleaners, fabric fresheners, and odor control products.

21. A rechargeable dispenser according to claim 20 wherein said disc shaped woven strip is formed from polyethylene and polypropylene fibers which have been bonded without the use of chemical binders.
